(19) United States
(12) Patent Application Publication
(10) Pub. No.: US 2019/0004805 A1
(43) Pub. Date: Jan. 3, 2019

(54) MULTI-TAGGED BRANCH PREDICTION TABLE

(71) Applicant: QUALCOMM Incorporated, San Diego, CA (US)

(72) Inventor: Rami Mohammad A. AL SHEIKH, Morrisville, NC (US)

(21) Appl. No.: 15/636,633

(22) Filed: Jun. 28, 2017

(51) Int. Cl. G06F 9/38

(52) U.S. Cl. CPC G06F 9/3844; G06F 9/3806

(57) ABSTRACT

Systems and methods pertain to a branch prediction table comprising one or more entries. Each entry comprises one or more branch prediction counters corresponding to one or more instructions in a fetch group of instructions fetched for processing in a processor. Each of the two or more fetch groups comprises at least one branch instruction for which at least one of the one or more branch prediction counters is used for making a branch prediction. Two or more tag fields are associated with each entry, wherein the two or more tag fields correspond to two or more fetch groups. In the event of a miss in the branch prediction table, updating the branch prediction counters and the two or more tag fields is performed in a manner which enables constructive aliasing and prevents destructive aliasing.

### FIELD OF DISCLOSURE

Disclosed aspects relate to branch prediction in processing systems. More particularly, exemplary aspects are directed to a branch prediction table configured with two or more tags for each entry.

### BACKGROUND

Processing systems may employ instructions which cause a change in control flow, such as conditional branch instructions. The direction of a conditional branch instruction is based on how a condition evaluates, but the evaluation may only be known deep down an instruction pipeline of a processor. To avoid stalling the pipeline until the evaluation is known, the processor may employ branch prediction mechanisms to predict the direction of the conditional branch instruction early in the pipeline. Based on the prediction, the processor can speculatively fetch and execute instructions from a predicted address in one of two paths—a “taken” path which starts at the branch target address, or a “not-taken” path which starts at the next sequential address after the conditional branch instruction.

When the condition is evaluated and the actual branch direction is determined, if the branch was mispredicted, (i.e., execution followed a wrong path) the speculatively fetched instructions may be flushed from the pipeline, and new instructions in a correct path may be fetched from the correct next address. Accordingly, improving accuracy of branch prediction for conditional branch instructions mitigates penalties associated with mispredictions and execution of wrong path instructions, and correspondingly improves performance and energy utilization of a processing system.

Conventional branch prediction mechanisms may include one or more state machines which may be trained with a history of evaluation of past and current branch instructions. The state machines may be organized in a table referred to as a branch prediction table. The branch prediction table may include entries comprising state machines for the conditional branch instructions, wherein the entries may be indexed and tagged using the addresses of the conditional branch instructions. The structure of a branch prediction table may be expanded to accommodate instruction set architectures wherein more than one instruction may be fetched and executed in each processing cycle.

For example, in a superscalar processor, a fetch group comprising one or more instructions may be fetched each cycle. The instructions in each fetch group may be chosen (e.g., by a compiler) to exploit the instruction-level parallelism that may be supported by the superscalar processor. For example, the instructions in a fetch group may be organized in a manner which maximizes utilization of hardware and/or software support for parallel execution of instructions in a fetch group. Although it is possible for two or more branch instructions to be present in a fetch group, in general, it is more likely that each fetch group is designed to comprise at most one branch instruction. However, the position(s) of one or more branch instructions, if present in a fetch group, may vary across different fetch groups.

In conventional implementations, branch prediction tables for superscalar processors may be overdesigned, in the sense that they may be provided with the capacity to deliver predictions for even the unlikely cases in which all instructions in a fetch group are branch instructions. Put another way, each entry of a conventional branch prediction table may have branch prediction mechanisms for each possible instruction position in a fetch group such that the maximum number of predictions which may be provided by each entry may be equal to the maximum number of instructions which may be present in a fetch group. For instance, there may be multiple branch prediction mechanisms such as state machines which may be available for potentially predicting multiple branch instructions, if present, in a fetch group.

Although a branch prediction table for a superscalar processor may be overdesigned with multiple branch prediction mechanisms for multiple instructions in a fetch group, each entry of the branch prediction table may be commonly tagged for the fetch group. The common tag may based on a characteristic of the fetch group such as a common address or identity of the fetch group. However, having a common tag for multiple branch prediction mechanisms in each entry leads to underutilization of the multiple branch prediction mechanisms since in the likely scenarios, there may be at most one branch instruction in each fetch group.

Yet another problem with the conventional implementations with a common tag relates to aliasing. In this context, aliasing refers to a phenomenon wherein multiple fetch groups may index into and update the same entry of a branch prediction table. For example, if there had been no tag to confirm whether the indexed entry is the correct one for a particular fetch group, then different fetch groups may cause the branch prediction mechanisms of the indexed entry to be updated. While these updates or effects of aliasing may be disruptive (e.g., corrupt the history of prior branch evaluations), in some situations it is seen that the aliasing may be constructive, which is desirable. Constructive aliasing may be a likely outcome in several cases, e.g., wherein programs may impute common behaviors to different branch instructions such that the different branch instructions may benefit from constructive aliasing. However, if the common tag is utilized to filter updates to the branch prediction table, then all manners of aliasing including the beneficial constructive aliasing may be eliminated.

Accordingly, it is desirable to improve utilization and efficiency of the branch prediction tables described above while avoiding the aforementioned drawbacks of conventional implementations.

### SUMMARY

Exemplary aspects of the invention are directed to systems and method for branch prediction. An exemplary branch prediction table comprises one or more entries. Each entry comprises one or more branch prediction counters corresponding to one or more instructions in a fetch group of instructions fetched for processing in a processor. Each of the two or more fetch groups comprises at least one branch instruction for which at least one of the one or more branch prediction counters is used for making a branch prediction. Two or more tag fields are associated with each entry, wherein the two or more tag fields correspond to two or more fetch groups. In the event of a miss in the branch prediction table, in exemplary aspects, updating the branch prediction counters and the two or more tag fields is performed in a manner which enables constructive aliasing and prevents destructive aliasing.

Accordingly, an exemplary aspect is directed to a branch prediction table comprising one or more entries, wherein each entry comprises one or more branch prediction counters corresponding to one or more instructions in a fetch group of instructions fetched for processing in a processor, and two or more tag fields associated with each entry, wherein the two or more tag fields correspond to two or more fetch groups.

Another exemplary aspect is directed to a method of branch prediction, the method comprising configuring a branch prediction table with one or more entries, wherein each entry comprises one or more branch prediction counters corresponding to one or more instructions in a fetch group of instructions fetched for processing in a processor, and associating two or more tag fields with each entry, wherein the two or more tag fields correspond to two or more fetch groups.

Another exemplary aspect is directed to an apparatus comprising a branch prediction table comprising one or more entries, wherein each entry comprises one or more means for branch prediction corresponding to one or more instructions in a fetch group of instructions fetched for processing in a processor, and two or more means for associating two or more fetch groups with each entry.

Yet another exemplary aspect is directed to a non-transitory computer readable storage medium comprising code, which, when executed by a processor, cause the processor to perform branch prediction, the non-transitory computer readable storage medium comprising code for configuring a branch prediction table with one or more entries, wherein each entry comprises one or more branch prediction counters corresponding to one or more instructions in a fetch group of instructions fetched for processing in a processor, and code for associating two or more tag fields with each entry, wherein the two or more tag fields correspond to two or more fetch groups.

### BRIEF DESCRIPTION OF THE DRAWINGS

The accompanying drawings are presented to aid in the description of aspects of the invention and are provided solely for illustration of the aspects and not limitation thereof.

FIG. 1 illustrates a conventional processing system with a conventional branch prediction table.

FIG. 2 illustrates an exemplary processing system with an exemplary multi-tagged branch prediction table according to aspects of this disclosure.

FIG. 3 illustrates a sequence of events pertaining to an exemplary multi-tagged branch prediction table according to aspects of this disclosure.

FIG. 4 is a flow-chart of a method of branch prediction using an exemplary multi-tagged branch prediction table according to aspects of this disclosure.

FIG. 5 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In exemplary aspects, a multi-tagged branch prediction table is disclosed, wherein each entry of the multi-tagged branch prediction table is tagged with two or more tags. The two or more tags may correspond to two or more fetch groups of instructions, fetched for example to be executed by a superscalar processor (wherein the superscalar processor may be configured to fetch two or more instructions in parallel in each one of the two or more fetch groups). Each entry of the multi-tagged branch prediction table may hold two or more branch prediction mechanisms, such as 2-bit branch prediction counters or 3-bit branch prediction counters as known in the art (and also briefly explained in the following sections). Since two or more fetch groups can utilize a single entry of the multi-tagged branch prediction table, the utilization of the multiple branch prediction mechanisms in each entry is improved. The various implementation details and possible configurations for exemplary multi-tagged branch prediction tables will be explained with references to the figures below.

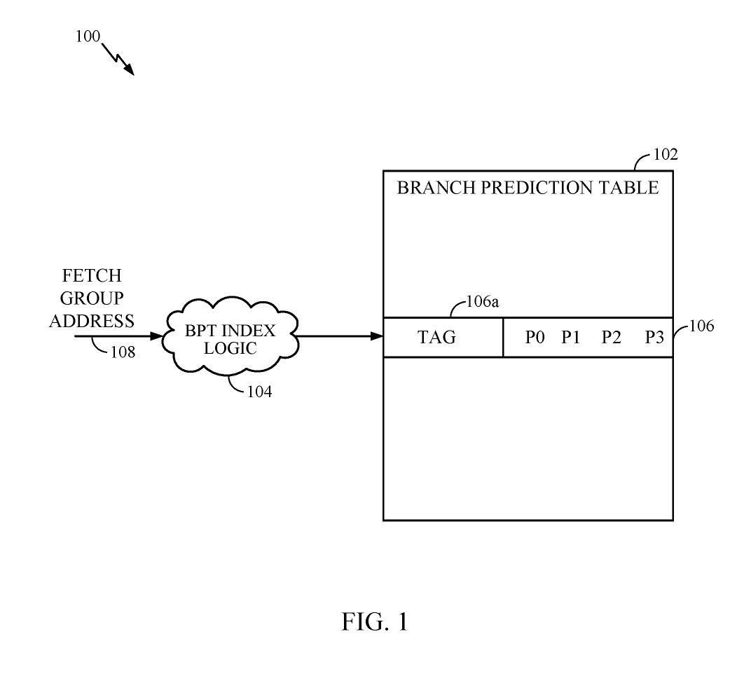

Referring now to FIG. 1, aspects of a conventional processing system 100 are shown. Particularly, a conventional branch prediction table (BPT) 102 is shown as a single-tagged structure, which will be further explained below. In each processing cycle, processing system 100 may support fetching a fetch group comprising multiple instructions for execution in an instruction pipeline (not explicitly illustrated). As such, processing system 100 may be configured as a superscalar processor, or a very long instruction word (VLIW) machine as known in the art. As shown, fetch group address 108 for a fetch group comprising up to four instructions may be combined with any other information such as a history of prior branch executions in BPT index logic 104. BPT index logic 104 may implement functionality such as a hash or other logical combinations on its inputs to point to a particular entry, e.g., entry 106 of BPT 102. Tag 106a may include at least a portion of a fetch group address 108. Tag 106a may be used to confirm that the indexed entry 106 is the correct entry of BPT 102 which holds a prediction for a branch instruction (if present in the fetch group) located at fetch group address 108. It is noted that in the conventional implementation shown, tag 106a is common to all instructions contained in the fetch group.

Information such as the address and past history provide a past behavior of branch instructions executed in processing system 100. Based on this information, branch prediction mechanisms in entries such as entry 106 of BPT 102 provide a prediction of how current branch instructions will execute (e.g., whether they will be taken or not-taken). More specifically, since each fetch group comprises up to four instructions in the above example, each entry of BPT 102, including entry 106, is provided with four branch prediction counters P0-P3 which are branch prediction mechanisms configured to provide branch predictions for branch instructions which may be located in a position corresponding to the branch prediction counters P0-P3 in the fetch group.

Branch prediction counters P0-P3 may each be implemented as a saturation counter, as known in the art. A two-bit saturation counter or a bimodal branch predictor will now be explained by way of background. The two-bit saturation counter is incremented each time a corresponding branch instruction evaluates in one direction, e.g., taken; and decremented each time the corresponding branch instruction evaluates in the other direction, i.e., not-taken. The value of the two-bit saturation counter represents a prediction, wherein conventionally, a binary value of “11” indicates a strongly predicted taken, “10” indicates a weakly predicted taken, “01” indicates a weakly predicted not-taken, and “11” indicates a strongly predicted not-taken. An advantage of the saturation counter lies in that a frequent evaluation in the same direction (i.e., at least two in the same direction) saturates or biases the prediction, but an infrequent evaluation in an opposite direction (e.g., only one misprediction) does not alter the predicted direction. Similar concepts may be extended to other types of prediction mechanisms, such as 3-bit saturation counters.

Regardless of the specific implementation of branch prediction counters P0-P3, it is seen that if only one branch instruction is present in a fetch group which indexes into entry 106 and whose tag matches tag 106a, then only a corresponding one out of the four branch prediction counters P0-P3 is utilized in making a branch prediction for that fetch group, while the remaining branch prediction counters P0-P3 are not utilized. Since the saturation counters consume valuable resources (e.g., software, hardware, or combinations thereof), it is desirable to improve the utilization of these resources.

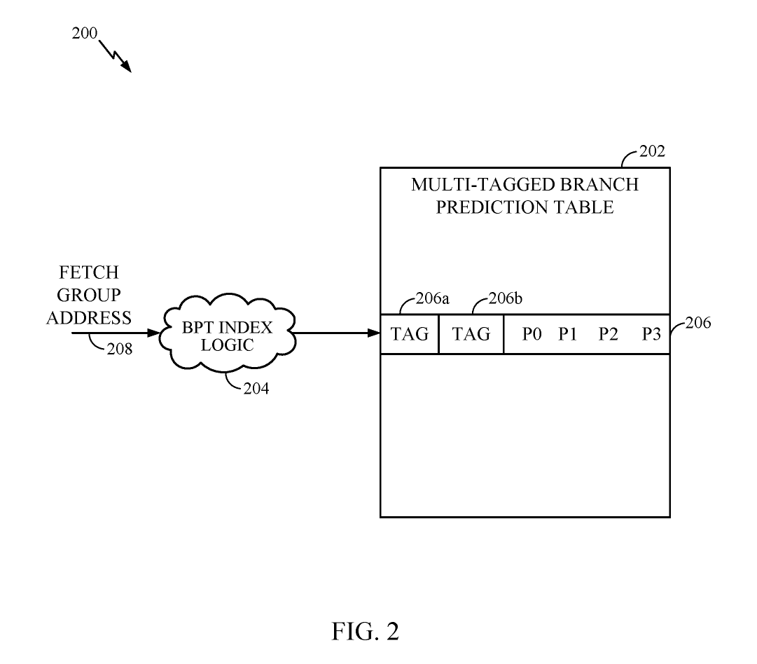

With reference now to FIG. 2, processing system 200 is shown with an exemplary multi-tagged branch prediction table 202 configured for a more efficient utilization of branch prediction resources. Specifically, FIG. 2 illustrates processing system 200 which may also be configured for fetching more than one instruction each processing cycle (e.g., designed with a superscalar architecture). Information such as fetch group address 208 of a fetch group of one or more instructions may be used by BPT index logic 204 for determining a particular entry 206 of BPT 202.

In an exemplary aspect, entry 206 may include multiple tags, of which tags 206a and 206b have been representatively shown. The multiple tags 206a-b may generally correspond to different fetch groups. In one instance which will be described further for the sake of illustration, the multiple tags 206a-b may include at least portions of addresses of different fetch groups which may index to the same entry 206. In some alternative aspects which are not discussed in greater detail, each of the multiple tags 206a-b may include at least portions of addresses of branch instructions in the different fetch groups. In yet other aspects, the multiple tags 206a-b may be formed based on any other function or logical combination of address bits or other identifiers of fetch groups, component branch instructions of the fetch groups, or combinations thereof.

In one example wherein tags 206a-b comprise portions of addresses of corresponding two fetch groups, one or more bits of fetch group address 208 may be used to determine which one of the multiple tags 206a-b may be associated with that particular fetch group address. For instance, if a specific bit, e.g., bit [n] of fetch group address 208 is “1” then tag 206a may be associated with that fetch group address; or if bit[n] is “0” then tag 206b may be associated with that fetch group address (in an example, the value of “n” may be “5” such that if bit[5] of fetch group address 208 is “1” then tag 206a comprising at least 6-bits of an address [5:0] whose bit[5] is “1” may be chosen, whereas if bit[5] of fetch group address 208 is “1” then tag 206b comprising at least 6-bits of an address [5:0] whose bit[5] is “1” may be chosen).

In various implementations of the multiple tags 206a-b, each one of tags 206a-b may be formed as different fields or contained in separate tag arrays, or in alternative implementations the multiple tags 206a-b may form portions of a wide tag array associated with BPT 202. However, it will be understood that the functionality described herein for multi-tag BPT 202 is applicable for these different implementations.

In an exemplary aspect, utilization of the resources of BPT 202 may be improved by configuring each entry of BPT 202 to be shared across multiple fetch groups for branch prediction of branches which may be contained therein. For example, the four branch prediction counters P0-P3 (which may be similarly configured as the branch prediction counters P0-P3 described with reference to FIG. 1) may be used in making branch predictions for branches which may be contained in at least two fetch groups which index into entry 206 and whose tags match one of the multiple tags 206a-b. It will be understood that there is no requirement for the number of tags associated with each entry to correspond to the number of branch prediction counters in the entry. Further operational details of the exemplary multi-tagged BPT 202 will now be provided with reference to the illustrated example of two tags 206a-b associated with an example entry 206 comprising four branch prediction counters P0-P3.

In one aspect, if a particular fetch group with fetch group address 208 indexes into entry 206 and one of tags 206a-b matches corresponding bits of fetch group address 208, then there is said to be hit for the fetch group in BPT 202. In the case of the hit, one or more branch instructions in the fetch group may obtain predictions from corresponding branch prediction counters P0-P3, and once evaluated (e.g., upon their execution being completed), the one or more branch instructions may update their corresponding branch prediction counters P0-P3.

In another aspect, neither one of tags 206a-b at indexed entry 206 may match the corresponding bits of fetch group address 208, resulting in a miss. In the case of the miss, an existing entry of BPT 202 (referred to as a victim entry) is evicted from BPT 202 to accommodate branch prediction information for the fetch group which missed in BPT 202.

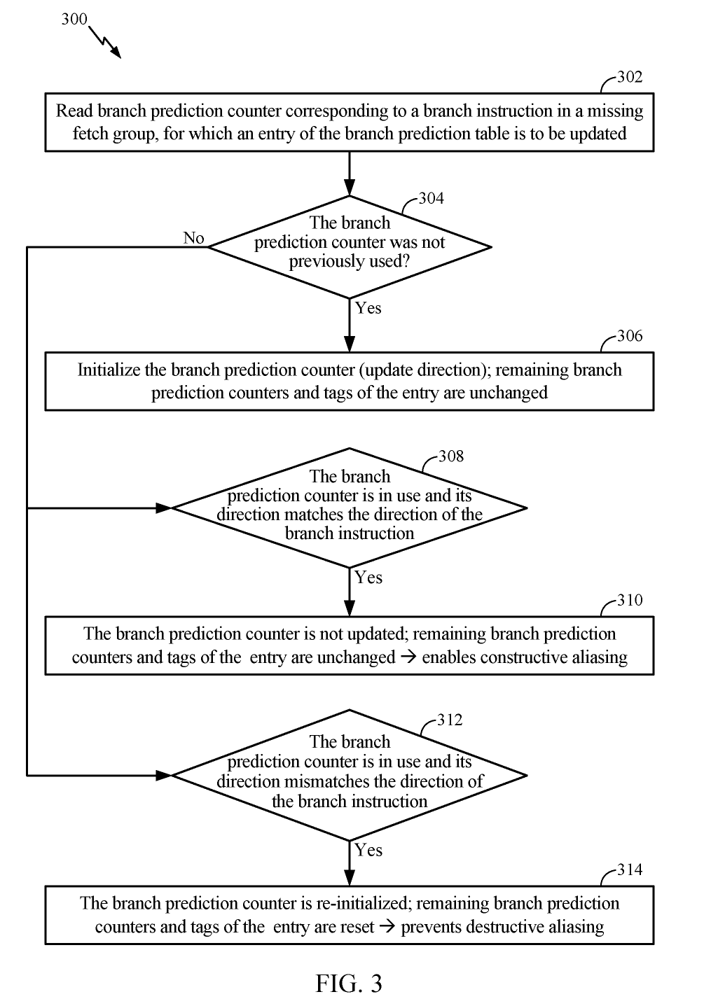

Subsequently the victim entry is replaced with a new entry corresponding to the missing fetch group in BPT 202. This involves updating a corresponding one of multiple tags. For example, if entry 206 is updated upon a missing fetch group with fetch group address 208 missing in BPT 202, the corresponding one of tags 206a-b (e.g., based on the previously described bit [n] of fetch group address 208 of the missing fetch group) is updated with corresponding bits of fetch group address 208 of the missing fetch group. Updates to the remaining tags and branch prediction counters P0-P3 of entry 206 will be explained with reference to FIG. 3.

In FIG. 3, a flow-chart for method 300 pertaining to an example sequence of actions related to BPT 202 of FIG. 2, is shown. Specifically, method 300 may be applicable in the event of a miss in BPT 202. It will be understood that the illustrated order in the sequence of events may be changed without deviating from the scope of this disclosure.

Starting with Block 302 subsequent to a miss in BPT 202 for a fetch group, entry 206 may be updated. In this regard, a corresponding one of branch prediction counters P0-P3 for a branch instruction in the fetch group may be read. In Block 304 it is determined whether the corresponding one of branch prediction counters P0-P3 was never used before (e.g., a use-indication bit which is set if a corresponding branch prediction counter was ever used, or some other similar mechanism, may be employed to track whether a corresponding branch prediction counter was previously used or updated). If the corresponding one of branch prediction counters P0-P3 was never used before, then in Block 306, the corresponding one of branch prediction counters P0-P3 is updated to reflect the direction of the branch instruction (e.g., incremented if the branch instruction was taken, or decremented if the branch instruction was not-taken, as explained in the case of the two-bit saturation counter in the previous sections). The remaining ones of branch prediction counters P0-P3 remain unchanged. Moreover, the remaining one of tags 206a-b in entry 206 which does not correspond to the missing fetch group is also left unchanged.

If in Block 304 it is determined that the corresponding one of branch prediction counters P0-P3 was used before, then method 300 may proceed to one of the two decision Blocks 308 or 312, which will now be explained.

In Block 308, it is determined whether the corresponding one of branch prediction counters P0-P3 was previously used or was previously updated, for example, with the evaluation of a branch instruction of the victim fetch group (or in other words, the corresponding one of branch prediction counters P0-P3 is currently in use), and the direction of the corresponding one of branch prediction counters P0-P3 matches the direction of the branch instruction in the missing fetch group. If yes, then in Block 310, the corresponding one of branch prediction counters P0-P3 is not updated. Furthermore, the remaining ones of branch prediction counters P0-P3 in entry 206 are also not updated and the remaining tag is also left unchanged. This process shown in Block 310 can enable “constructive aliasing”, wherein constructive aliasing in this context, refers to reusing the prediction history developed by the corresponding one of branch prediction counters P0-P3 whose direction matches the direction of the branch instruction in the missing fetch group in making future predictions for the branch instruction in the missing fetch group.

The constructive aliasing as described above is enabled because the victim entry which was evicted or replaced is located at the same index as the missing fetch group and the corresponding one of branch prediction counters P0-P3 for the victim entry matches the direction of the branch instruction of the missing fetch group. By not updating branch prediction counters P0-P3 which were previously updated (e.g., by the victim entry or entries prior to the victim entry in the same indexed location of BPT 202), the behavioral history of prior branch instructions is preserved in the corresponding branch prediction counters P0-P3, which can desirably lead to the above-described constructive aliasing.

On the other hand, if in Block 312, it is determined that the corresponding one of branch prediction counters P0-P3 was previously used (or is in use) and the direction of the corresponding one of branch prediction counters P0-P3 does not match the direction of the branch instruction in the missing fetch group, then in Block 314, the corresponding one of branch prediction counters P0-P3 is re-initialized. Re-initialization of the corresponding one of branch prediction counters P0-P3 involves resetting to an initial or neutral state (if applicable) and updating the direction to that of the branch instruction (e.g., if branch prediction counters P0-P3 are two-bit saturation counters and the branch instruction is taken, then re-initialization of one of branch prediction counters P0-P3 corresponding to the branch instruction would mean setting the corresponding one of branch prediction counters P0-P3 to a “01” or weakly taken indication).

Furthermore, in Block 314, the remaining ones of branch prediction counters P0-P3 in entry 206 are reset and the remaining tag is also reset. Resetting the remaining ones of branch prediction counters P0-P3 and the remaining tag prevents “destructive aliasing”. In this context, destructive aliasing refers to the ability of the corresponding one of branch prediction counters P0-P3 in the victim entry which was evicted and whose direction does not match the direction of the branch instruction of the missing fetch group to destroy or negatively influence the future prediction capability of the corresponding one of branch prediction counters P0-P3 in predicting the direction of the ranch instruction of the missing fetch group.

To further explain, since the direction of the corresponding one of branch prediction counters P0-P3 in the victim entry which was evicted does not match the direction of the branch instruction of the missing fetch group, if the corresponding one of branch prediction counters P0-P3 in the victim entry was left unchanged, the corresponding one of branch prediction counters P0-P3 would not reflect the behavior of the branch instruction of the missing fetch group which replaces the victim entry. Therefore, reusing the corresponding one of branch prediction counters P0-P3 for predicting the direction of the branch instruction of the missing fetch group would lead to an undesirable destruction of the ability of the corresponding one of branch prediction counters P0-P3 in predicting the direction of the branch instruction of the missing fetch group. To avoid this potential for destructive aliasing, re-initialization of the corresponding one of branch prediction counters P0-P3 as described above resets the corresponding one of branch prediction counters P0-P3 and then the direction of the corresponding one of branch prediction counters P0-P3 is updated to that of the branch instruction of the missing fetch group.

In this manner, in exemplary aspects, a multi-tagged branch prediction table may be configured for processors such as processing system 200 (e.g., configured for superscalar processing) to improve utilization of the prediction mechanisms in each entry of the multi-tagged branch prediction table, while enabling constructive aliasing and minimizing destructive aliasing.

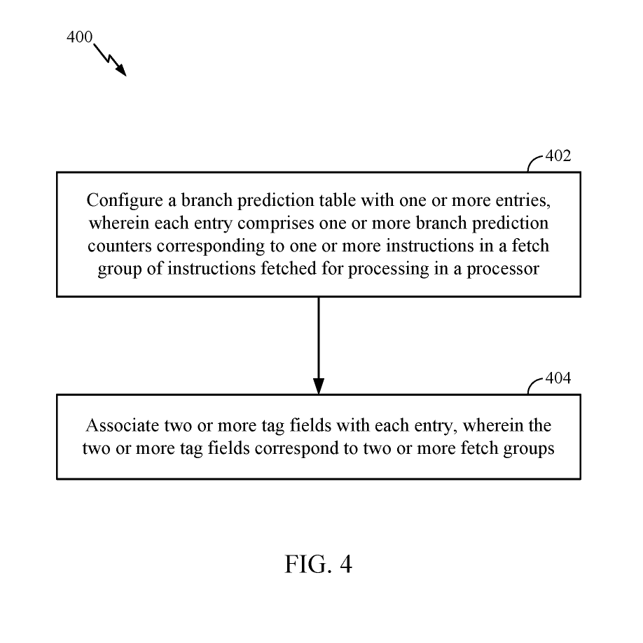

Accordingly, it will be appreciated that exemplary aspects include various methods for performing the processes, functions and/or algorithms disclosed herein. For example, FIG. 4 illustrates a method 400 of branch prediction, e.g., using a multi-tagged branch prediction table such as BPT 202.

As shown, Block 402 of method 400 comprises configuring a branch prediction table (e.g., BPT 202) with one or more entries (e.g., entry 206), wherein each entry comprises one or more branch prediction counters (e.g., branch prediction counters P0-P3) corresponding to one or more instructions in a fetch group of instructions (e.g., at fetch group address 208) fetched for processing in a processor (e.g., processing system 200).

Block 404 comprises associating two or more tag fields (e.g., tag fields 206a-b) with each entry, wherein the two or more tag fields correspond to two or more fetch groups.

In method 400, each of the two or more fetch groups may comprise at least one branch instruction for which at least one of the one or more branch prediction counters is used for making a branch prediction. As previously mentioned, the above-referenced two or more tag fields may correspond to the two or more fetch groups in any manner, including, comprising at least portions of addresses of the two or more fetch groups, comprising at least portions of addresses of branch instructions comprised in the two or more fetch groups, or combinations thereof.

In further aspects, method 400 may involve determining that there is a hit in the branch prediction table for a first branch instruction of a first fetch group, if the branch prediction table comprises a first tag field associated with a first entry, wherein the first tag field corresponds to the first fetch group, and wherein the first entry comprises a first branch prediction counter configured for providing a branch prediction for the first branch instruction (e.g., if a particular fetch group with fetch group address 208 indexes into entry 206 and one of tags 206a-b matches corresponding bits of fetch group address 208; one or more branch instructions in the fetch group may obtain predictions from corresponding branch prediction counters P0-P3, and once evaluated (e.g., upon their execution being completed), the one or more branch instructions may update their corresponding branch prediction counters P0-P3).

Method 400 may also include determining that there is a miss in the branch prediction table for a first branch instruction of a first fetch group, if the branch prediction table does not comprises a first tag field associated with a first entry, wherein the first tag field corresponds to the first fetch group. For example, if neither one of tags 206a-b at indexed entry 206 match the corresponding bits of fetch group address 208, this would result in a miss in BPT 202. In the case of a miss, an existing entry of BPT 202 (referred to as a victim entry) is evicted from BPT 202 to accommodate branch prediction information for the fetch group which missed in BPT 202.

Pursuant to a miss, method 400 may further involve updating the branch prediction table to include the first entry with the first tag field to correspond to the first fetch group. For example, if entry 206 is updated upon the fetch group missing in BPT 202, the corresponding one of tags 206a-b (e.g., based on bit [5] of fetch group address 208 of the missing fetch group) is updated with corresponding bits of the missing fetch group's address.

Furthermore, method 400 may also include the processes explained with reference to FIG. 3, in the event of a miss. For example, if a direction of a first branch prediction counter in the first entry, the first branch instruction corresponding to the first branch instruction, matches a resolved direction of the first branch instruction, the method may include not updating the first branch prediction counter, to enable constructive aliasing (see, e.g., Blocks 308-310).

On the other hand, if a direction of a first branch prediction counter in the first entry, the first branch prediction counter corresponding to the first branch instruction, mismatches a resolved direction of the first branch instruction, method 400 may involve resetting the first branch prediction counter and updating a direction of the first branch prediction counter to correspond to the resolved direction, to prevent destructive aliasing (see, e.g., Blocks 312-314). Further aspects may also include resetting one or more additional branch prediction counters in the first entry, and resetting one or more additional tag fields associated with the first entry, as explained with reference to Blocks 312-314 of FIG. 3.

Also, in various aspects compatible with method 400, as previously mentioned, the two or more tag fields may be configured as portions of a wide tag field, or as two or more tag field arrays.

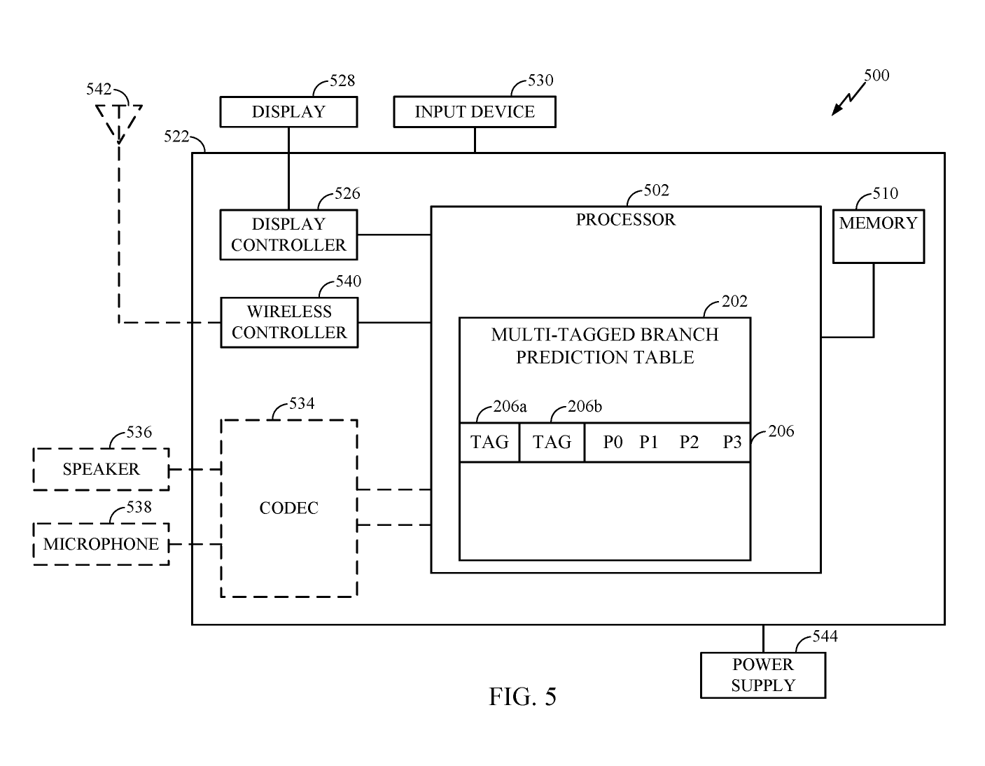

An example apparatus in which exemplary aspects of this disclosure may be utilized, will now be discussed in relation to FIG. 5. FIG. 5 shows a block diagram of computing device 500. Computing device 500 may correspond to an exemplary implementation of a processing system (e.g., processing system 200) configured to perform method 400 of FIG. 4. In the depiction of FIG. 5, computing device 500 is shown to include processor 502 (which may be a superscalar processor) comprising BPT 202 of FIG. 2 discussed previously. In FIG. 5, processor 502 is exemplarily shown to be coupled to memory 510 and it will be understood that other memory configurations known in the art may also be supported by computing device 500.

FIG. 5 also shows display controller 526 that is coupled to processor 502 and to display 528. In some cases, computing device 500 may be used for wireless communication and FIG. 5 also shows optional blocks in dashed lines, such as coder/decoder (CODEC) 534 (e.g., an audio and/or voice CODEC) coupled to processor 502 and speaker 536 and microphone 538 can be coupled to CODEC 534; and wireless antenna 542 coupled to wireless controller 540 which is coupled to processor 502. Where one or more of these optional blocks are present, in a particular aspect, processor 502, display controller 526, memory 510, and wireless controller 540 are included in a system-in-package or system-on-chip device 522.

Accordingly, a particular aspect, input device 530 and power supply 544 are coupled to the system-on-chip device 522. Moreover, in a particular aspect, as illustrated in FIG. 5, where one or more optional blocks are present, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

It should be noted that although FIG. 5 generally depicts a computing device, processor 502 and memory 510, may also be integrated into a set top box, a server, a music player, a video player, an entertainment unit, a navigation device, a personal digital assistant (PDA), a fixed location data unit, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for branch prediction using a multi-tagged branch prediction table. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. An apparatus comprising:
a branch prediction table comprising one or more entries, wherein each entry comprises one or more branch prediction counters corresponding to one or more instructions in a fetch group of instructions fetched for processing in a processor; and
two or more tag fields associated with each entry, wherein the two or more tag fields correspond to two or more fetch groups.

2. The apparatus of claim 1, wherein the two or more tag fields comprise at least portions of addresses of the two or more fetch groups.

3. The apparatus of claim 1, wherein the two or more tag fields comprise at least portions of addresses of branch instructions comprised in the two or more fetch groups.

4. The apparatus of claim 1, wherein each of the two or more fetch groups comprises at least one branch instruction for which at least one of the one or more branch prediction counters is used for making a branch prediction.

5. The apparatus of claim 1, wherein if there is a hit in the branch prediction table for a first branch instruction of a first fetch group, the branch prediction table comprises a first tag field associated with a first entry, wherein the first tag field corresponds to the first fetch group, and wherein the first entry comprises a first branch prediction counter configured to provide a branch prediction for the first branch instruction.

6. The apparatus of claim 1, wherein if there is a miss in the branch prediction table for a first branch instruction of a first fetch group, a first tag field of the branch prediction table associated with a first entry is updated to correspond to the first fetch group.

7. The apparatus of claim 6, wherein, if a direction of a first branch prediction counter in the first entry, the first branch instruction corresponding to the first branch instruction, matches a resolved direction of the first branch instruction, the first branch prediction counter is not updated, to enable constructive aliasing.

8. The apparatus of claim 6, if a direction of a first branch prediction counter in the first entry, the first branch prediction counter corresponding to the first branch instruction, mismatches a resolved direction of the first branch instruction, the first branch prediction counter is reset and a direction of the first branch prediction counter is updated to correspond to the resolved direction, to prevent destructive aliasing.

9. The apparatus of claim 8, wherein one or more additional branch prediction counters in the first entry are reset.

10. The apparatus of claim 8, wherein one or more additional tag fields associated with the first entry are reset.

11. The apparatus of claim 1, wherein the two or more tag fields are portions of a wide tag field.

12. The apparatus of claim 1, wherein the two or more tag fields are configured as corresponding two or more tag field arrays.

13. The apparatus of claim 1, wherein the processor is a superscalar processor configured to fetch two or more instructions in parallel in each one of the two or more fetch groups.

14. The apparatus of claim 1, integrated into a device selected from the group comprising a set top box, a server, a music player, a video player, an entertainment unit, a navigation device, a personal digital assistant (PDA), a fixed location data unit, a computer, a laptop, a tablet, a communications device, a mobile phone.

15. A method of branch prediction, the method comprising:
configuring a branch prediction table with one or more entries, wherein each entry comprises one or more branch prediction counters corresponding to one or more instructions in a fetch group of instructions fetched for processing in a processor; and
associating two or more tag fields with each entry, wherein the two or more tag fields correspond to two or more fetch groups.

16. The method of claim 15, wherein the two or more tag fields comprise at least portions of addresses of the two or more fetch groups.

17. The method of claim 15, wherein the two or more tag fields comprise at least portions of addresses of branch instructions comprised in the two or more fetch groups.

18. The method of claim 15, wherein each of the two or more fetch groups comprises at least one branch instruction for which at least one of the one or more branch prediction counters is used for making a branch prediction.

19. The method of claim 15, further comprising determining that there is a hit in the branch prediction table for a first branch instruction of a first fetch group, if the branch prediction table comprises a first tag field associated with a first entry, wherein the first tag field corresponds to the first fetch group, and wherein the first entry comprises a first branch prediction counter configured for providing a branch prediction for the first branch instruction.

20. The method of claim 15, further comprising determining that there is a miss in the branch prediction table for a first branch instruction of a first fetch group, if the branch prediction table does not comprises a first tag field associated with a first entry, wherein the first tag field corresponds to the first fetch group.

21. The method of claim 20, further comprising updating the branch prediction table to include the first entry with the first tag field to correspond to the first fetch group.

22. The method of claim 21, further comprising, if a direction of a first branch prediction counter in the first entry, the first branch instruction corresponding to the first branch instruction, matches a resolved direction of the first branch instruction, not updating the first branch prediction counter, to enable constructive aliasing.

23. The method of claim 21, further comprising, if a direction of a first branch prediction counter in the first entry, the first branch prediction counter corresponding to the first branch instruction, mismatches a resolved direction of the first branch instruction, resetting the first branch prediction counter and updating a direction of the first branch prediction counter to correspond to the resolved direction, to prevent destructive aliasing.

24. The method of claim 23, further comprising resetting one or more additional branch prediction counters in the first entry.

25. The method of claim 23, further comprising resetting one or more additional tag fields associated with the first entry.

26. The method of claim 15, comprising configuring the two or more tag fields as portions of a wide tag field.

27. The method of claim 15, comprising configuring the two or more tag fields as two or more tag field arrays.

28. An apparatus comprising:
a branch prediction table comprising one or more entries, wherein each entry comprises one or more means for branch prediction corresponding to one or more instructions in a fetch group of instructions fetched for processing in a processor; and
two or more means for associating two or more fetch groups with each entry.

29. A non-transitory computer readable storage medium comprising code, which, when executed by a processor, cause the processor to perform branch prediction, the non-transitory computer readable storage medium comprising:
code for configuring a branch prediction table with one or more entries, wherein each entry comprises one or more branch prediction counters corresponding to one or more instructions in a fetch group of instructions fetched for processing in a processor; and
code for associating two or more tag fields with each entry, wherein the two or more tag fields correspond to two or more fetch groups.
